(19) United States
(12) Patent Application Publication
(10) Pub. No.: US 2020/0283908 A1
(43) Pub. Date: Sep. 10, 2020

(54) PROTECTIVE COATING COMPOSITION AND COATED METALLIC SUBSTRATE COMPRISING SAME

(71) Applicant: Momentive Performance Materials Inc., Waterford, NY (US)

(72) Inventors: Rajkumar Jana, Bangalore (IN); Raghavendra Prasad, Bangalore (IN); Karthikeyan Murugesan, Bangalore (IN)

(21) Appl. No.: 16/291,588

(22) Filed: Mar. 4, 2019

(51) Int. Cl. C23C 22/56; C23C 22/82; C09D 5/08; C09D 7/61; C09D 7/40

(52) U.S. Cl. CPC C23C 22/56; C23C 22/82; C09D 5/08; C08K 9/06; C09D 7/67; C23C 2222/20; C09D 7/61

(57) ABSTRACT

A surface-protective coating forming composition exhibiting excellent shelf life (e.g. storage stability) and cured coating performance is derived from alkoxysilane and silica nanoparticles.

### FIELD OF THE INVENTION

This invention relates to surface-protective coating compositions, e.g., conversion and passivation coatings, and more particularly to curable coating compositions derived from alkoxysilanes and to methods of using such compositions for coating substrates therewith.

### BACKGROUND

Metal and metal alloys in exterior applications are often exposed to conditions that can corrode the surface through acid-base reactions and electrochemical corrosion, which can cause loss of mechanical strength and diminish the appearance of the finished metallic surfaces. Aluminum and/or aluminum alloys are the preferred material for exterior applications due to the weight to strength ratio of such materials (light metal). Aluminum, however, is also a very soft metal that makes it prone to mechanical damage. For example, it may exhibit poor abrasion resistance, which leads to scratches. Aluminum is also susceptible to corrosion through exposure to acidic and basic conditions.

One approach to address these issues is to subject an aluminum material to an electrochemical process called anodization that deposits a uniform layer of aluminum oxide followed by sealing to close pores on the anodized surface. The anodized layer exhibits relatively better abrasion, corrosion, and pH resistant (pH 4-9) compared to the non-anodized aluminum. However, the anodization process is a multistep, time consuming, and chemically intensive process. Also, anodization may not be sufficient alone for some demanding applications where stringent performances are desired such as resistance against highly acidic and basic conditions.

To protect the anodized layer against corrosive conditions, a protective coating layer is often applied that can provide resistance against extreme acidic and basic conditions, and resistance against electrochemical corrosion by providing a barrier to the underneath layer in addition to good optical and abrasion resistance properties. Chromium and heavy metal phosphate conversion coatings have been used to prepare metal surfaces prior to painting. However, growing concerns regarding the toxicity of chromium and the polluting effects of chromates, phosphates, and other heavy metals discharged into streams, rivers and other waterways as industrial wastes have driven the quest for alternatives to such metal coating compositions.

One type of surface protective coating composition that has emerged from efforts to develop non-chromium, non-phosphate, and non-heavy metal based metal coating compositions is derived from alkoxysilanes. While curable coating compositions derived from alkoxysilanes continue to attract a high level of interest within the metals industry, with some formulations having achieved wide-spread commercial acceptance, there remains considerable room for improvement in one or more of their properties that continue to be of major importance to metal fabricators and processors, e.g., the storage stability of the uncured compositions as well as the adhesion, flexibility, corrosion resistance, abrasion/wear resistance, and/or optical clarity properties of the cured compositions. It will be highly useful to have a single protective coating layer, that can directly adhere to bulk/bare aluminum bypassing anodization and sealing processes while providing the protection to the aluminum substrate as similar to anodized Aluminum. The major advantage of this approach (coating directly on bulk/bare Al) is that it can provide options to avoid pre-treatment, anodization, or sealing steps. The key challenge associated with protective coatings for such substrates like aluminum bulk metal is strong adhesion while providing barrier to acid, alkali, and corrosive mediums for better performance.

In addition to the performance requirements, a matte appearance of the finished surface may be desired in some application for styling purposes for example automotive trim parts. Currently a matte finish is achieved by chemical etching processes prior to anodization. The entire process of preparing a matte finished anodized surface typically involves multistep cleaning, etching, anodization, and sealing processes. These processes are time consuming, chemically intensive, and can be hazardous. In addition, a protective coating layer may be required in demanding applications to meet stringent performance properties such as resistance against highly acidic and basic conditions, and corrosion resistance anodization may not be sufficient alone to provide a sufficient coating.

### SUMMARY

In accordance with an aspect of the invention, there is provided a curable surface-protective coating forming composition for application to protect the surface of a substrate such as one of metal, metal alloy, metallized part, metal or metallized parts possessing one or more protective layers, metallized plastics, metal sputtered plastics, or primed plastic materials, the coating forming composition comprising:

(i) at least one alkoxysilane
(ii) silica nano-particles;
(iii) a zirconium based compound;
(iv) at least one acid hydrolysis catalyst;
(v) water;
(vi) optionally a matting agent;
(vii) optionally solvents; and
(viii) optionally, at least one condensation catalyst; and
(ix) optionally one or more additional additives.

In an embodiment, the coating composition provides a clear coating when coated on a metal, metal alloy, metallized part, metal or metallized parts possessing one or more protective layers, metallized plastics, metal sputtered plastics, or primed plastic materials.

In one embodiment, the at least one alkoxy silane is selected from the group consisting of Formula A, Formula B, or a mixture of Formula A and Formula B:

(X—R¹)ₐSi(R²)_{b}(OR³)_{4-(a+b)} Formula A

(R³O)₃Si—R⁵—Si(OR³)₃ Formula B

or hydrolyzed and condensed products thereof, wherein:

X is an organofunctional group;

each R¹ is a linear, branched or cyclic divalent organic group of from 1 to about 12 carbon atoms optionally containing one or more heteroatoms;

each R² independently is an alkyl, aryl, alkaryl or aralkyl group of from 1 to about 16 carbon atoms, optionally containing one or more halogen atoms;

each R³ independently is an alkyl group of from 1 to about 12 carbon atoms;

R⁵ is a linear, branched or cyclic divalent organic group of from 1 to about 12 carbon atoms optionally containing one or more heteroatoms; and

subscript a is 0 or 1, subscript b is 0, 1 or 2 and a+b is 0, 1 or 2.

In one embodiment, the total amount of alkoxysilane of Formulas A and B does not exceed about 80 weight percent of the coating forming composition.

In one embodiment, in the alkoxysilane of Formula A, a is 1 and organofunctional group X is a mercapto, acyloxy, glycidoxy, epoxy, epoxycyclohexyl, epoxycyclohexylethyl, hydroxy, episulfide, acrylate, methacrylate, ureido, thioureido, vinyl, allyl, —NHCOOR⁴ or —NHCOSR⁴ group in which R⁴ is a monovalent hydrocarbyl group containing from 1 to about 12 carbon atoms thiocarbamate, dithiocarbamate, ether, thioether, disulfide, trisulfide, tetrasulfide, pentasulfide, hexasulfide, polysulfide, xanthate, trithiocarbonate, dithiocarbonate or isocyanurato group, or another —Si(OR³) group wherein R³ is as previously defined.

In one embodiment, in the alkoxysilane of formula B, R⁵ is a divalent hydrocarbon group containing at least one heteroatom selected from the group consisting of O, S and NR⁶ in which R⁶ is hydrogen or an alkyl group of from 1 to about 4 carbon atoms.

In one embodiment, the trialkoxysilane of Formula A is at least one member selected from the group consisting of methyltrimethoxysilane, methyltriethoxysilane, ethyltrimethoxysilane, ethyltriethoxysilane, ethyltripropoxysilane, n-propyltrimethoxysilane, n-propyltriethoxysilane, n-propyltripropoxysilane, n-propyltributoxysilane, n-butyltrimethoxysilane, isobutyltrimethoxysilane, n-pentyltrimethoxysilane, n-hexyltrimethoxysilane, isoocyltriethoxysilane, vinyltrimethoxysilane, vinyltriethoxysilane, phenyltrimethoxysilane, phenyltriethoxysilane, octyltrimethoxysilane, trifluoropropyltrimethoxysilane, 3-aminopropyltrimethoxysilane, 3-mercaptopropyltrimethoxysilane, 3-mercaptopropyltriethoxysilane, 3-glycidoxypropyltrimethoxysilane and 3-glycidoxypropyltriethoxysilane, and wherein the trialkoxysilane of Formula B is at least one member selected from the group consisting of 1,2-bis(trimethoxysilyl)ethane, 1,2-bis(triethoxysilyl)ethane, bis(trimethoxysilylpropyl)disulfide, bis(triethoxysilylpropyl)disulfide, bis(trimethoxysilylpropyl)tetrasulfide, bis(triethoxysilylpropyl)tetrasulfide, bis(3-triethoxysilylpropyl)amine, and bis(3-trimethoxysilylpropyl)amine.

In embodiment, the silica nano-particles are chosen from colloidal silica.

In one embodiment, the silica nano-particles are present in an amount of from about 5 to about 50 weight percent based on the weight of the composition.

In an embodiment, the zirconium based compound is chosen from a zirconium salt, a zircoaluminate, a zirconate, or a combination of two or more thereof.

In another embodiment, the zircoaluminate and the zirconate have a neutral or acidic pH.

In an embodiment of the composition, the adhesion promoter is present in an amount of from about 0.1 to about 10 weight percent based on the weight of the composition.

In another embodiment, the adhesion promoter is present in an amount of from about 0.25 to about 7.5 weight percent based on the weight of the composition.

In one embodiment, the at least one acid hydrolysis catalyst (iv) is at least one member selected from the group consisting of sulfuric acid, hydrochloric acid, acetic acid, propanoic acid, 2-methyl propanoic acid, butanoic acid, pentanoic acid (valeric acid), hexanoic acid (caproic acid), 2-ethylhexanoic acid, heptanoic acid (enanthic acid), hexanoic acid, octanoic acid (caprylic acid), oleic acid, linoleic acid, cyclohexanecarboxylic acid, cyclohexylacetic acid, cyclohexenecarboxylic acid, benzoic acid, benzeneacetic acid, propanedioic acid (malonic acid), butanedioic acid (succinic acid), hexanedioic acid (adipic acid), 2-butenedioic acid (maleic acid), lauric acid, stearic acid, myristic acid, palmitic acid, isoanoic acid, versatic acid, and amino acid, and wherein the coating forming composition also contains at least one condensation catalyst (vi) selected from the group consisting of tetrabutylammonium carboxylates of the formula [(C₄H₉)₄N]⁺[OC(O)—R⁷]⁻ in which R⁷ is selected from the group consisting of hydrogen, alkyl groups containing from 1 to about 8 carbon atoms, and aromatic groups containing about 6 to about 20 carbon atoms.

In one embodiment, the coating forming composition includes the matting agent (vi). The matting agent may be an inorganic compound or an organic compound. In one embodiment, the matting agent is chosen from a functionalized silica. In one embodiment, the matting agent is a silicone resin material.

In one embodiment, the matting agent is selected from an inorganic compound or an organic compound.

In one embodiment, the matting agent is chosen from silicon dioxide, calcined calcium silicate, hydrated calcium silicate, aluminum silicate, magnesium silicate, titanium oxide, zinc oxide, aluminum oxide, barium oxide, zirconium oxide, strontium oxide, antimony oxide, tin oxide, antimony-doped tin oxide, calcium carbonate, talc, clay, calcined kaolin, calcium phosphate, a silicone resin, a fluororesin, an acrylic resin, or a mixture of two or more thereof.

In one embodiment, the matting agent is chosen from functionalized silica particles functionalized with a halosilane, an alkoxysilane, a silazane, a siloxane, or a combination of two or more thereof.

In one embodiment, the matting agent is present in an amount of from about 0.1 to about 10 weight percent based on the weight of the composition.

In one embodiment, the water-miscible solvent (vii) is at least one member selected from the group consisting of alcohol, glycol, glycol ether and ketone.

In one embodiment, the condensation catalyst (viii) is at least one member selected from the group consisting of tetra-n-butylammonium acetate, tetra-n-butylammonium formate, tetra-n-butylammonium benzoate, tetra-n-butylammonium-2-ethylhexanoate, tetra-n-butylammonium-p-ethylbenzoate, tetra-n-butylammonium propionate and TBD-acetate (1,5,7-triazabicyclo[4.4.0]dec-5-ene (TBD)).

In one embodiment, the composition has a viscosity within the range of from about 3.0 to about 7.0 cStks at 25° C.

In another aspect, provided is an article comprising a coating formed from the coating forming composition of any of the previous embodiments disposed on a surface of the article.

In one embodiment, the surface coated comprising the coating forming composition is formed from a metal, metal alloy, painted metal or metal alloy, passivated metal or metal alloy, metallized plastic, metal sputtered plastic, or a primed plastic materials.

In one embodiment, the metal is selected from steel, chrome, stainless steel, aluminum, anodized aluminum, magnesium, copper, bronze, or an alloy of two or more of these metals.

In still another aspect, provided is a method of forming a coating on a surface of an article comprising: applying the coating forming composition on a surface of the article; and curing the coating forming composition to form a coating.

In one embodiment, curing the coating forming composition comprises curing at a temperature of about 80 to about 200° C.

Further, in another aspect is provided a process for forming the curable surface-protective coating forming composition according to any previous embodiment comprising:

a) mixing alkoxysilane(s) (i) and a portion of acid hydrolysis catalyst (iv);

b) adding metal oxide (ii) and water (v) to form the hydrolysate from step (a);

c) adding a water-miscible organic solvent (vii) and the remainder of acid hydrolysis catalyst (iv) to the mixture resulting from step (b);

d) aging the mixture resulting from step (c) under conditions of elevated temperature and for a period of time effective to provide a curable coating forming composition having a viscosity at 25° C. within the range of from about 3.0 to about 7.0 cStks, more specifically from about 4.0 to about 5.5 cStks and still more specifically from about 4.5 to about 5.0 cStks; and,

e) optionally, adding condensation catalyst (viii) at, during, or following any of the preceding steps, optionally adding the adhesion promoter (iii) at, during, or following any of the preceding steps, and/or optionally adding the additional additives (ix) at, during, or following any of the preceding steps.

In one embodiment, the process further comprises adding a matting agent (vi) to the composition. In one embodiment, the matting agent is added following step (d).

According to yet another aspect of the invention, a metal possessing a surface-protective coating, i.e., a coating which imparts corrosion resistance and/or abrasion resistance to a surface of a non-coated or pre-coated metal, is obtained by the coating process which further comprises: applying a coating of the foregoing coating forming composition to a non-coated or pre-coated surface of a metal; removing at least some solvent (vii) from the applied coating of coating forming composition; and curing the solvent-depleted coating of coating forming composition to provide a corrosion resistant and/or abrasion resistant coating on the metal surface.

The present curable coating forming compositions possess excellent storage stability and cured surface-protective coatings obtained therefrom tend to exhibit one or more functionally advantageous properties such as high levels of corrosion and abrasion resistance, adherence to metal surfaces, flexibility (resistance to cracking or crazing), and acid and/or alkali resistance. In addition, the generally outstanding optical clarity of the cured coatings herein allows the aesthetically attractive quality of the underlying substrate surface to be shown to good effect.

### DETAILED DESCRIPTION

In the specification and claims herein, the following terms and expression are to be understood as having the hereinafter indicated meanings.

The singular forms “a,” “an,” and “the” include the plural, and reference to a particular numerical value includes at least that particular value unless the context clearly dictates otherwise.

Other than in the working examples or where otherwise indicated, all numbers expressing amounts of materials, reaction conditions, time durations, quantified properties of materials, and so forth, stated in the specification and claims are to be understood as being modified in all instances by the term “about.”

All methods described herein may be performed in any suitable order unless otherwise indicated herein or otherwise clearly contradicted by context. The use of any and all examples or exemplary language (e.g., “such as”) provided herein is intended merely to better illuminate the invention and does not pose a limitation on the scope of the invention unless otherwise claimed.

No language in the specification should be construed as indicating any non-claimed element as essential to the practice of the invention.

As used herein, the terms “comprising,” “including,” “containing,” “characterized by,” and grammatical equivalents thereof are inclusive or open-ended terms that do not exclude additional, unrecited elements, or method steps, but will also be understood to include the more restrictive terms “consisting of” and “consisting essentially of.”

Composition percentages are given in weight percent unless otherwise indicated.

It will be understood that any numerical range recited herein includes all sub-ranges within that range and any combination of the various endpoints of such ranges or sub-ranges.

It will be further understood that any compound, material or substance which is expressly or implicitly disclosed in the specification and/or recited in a claim as belonging to a group of structurally, compositionally, and/or functionally related compounds, materials or substances includes individual representatives of the group and all combinations thereof.

The term “metal” as used herein shall be understood herein to apply to metals per se, metal alloys, metalized parts, and metal or metalized parts possessing one or more non-metallic protective layers.

By “hydrolytically condensed” is meant that one or more silanes in the coating composition-forming mixture are first hydrolyzed followed by the condensation reaction of hydrolyzed product with itself or with other hydrolyzed and/or unhydrolyzed components of the mixture.

The coating compositions comprise: (i) at least one alkoxysilane; (ii) colloidal silica; (iii) zirconium based compound; (iv) at least one acid hydrolysis catalyst; (v) water; (vi) optionally, a matting agent; (vii) optionally, one or more solvents; (viii) optionally, at least one condensation catalyst; and (ix) optionally one or more additional additives. In one aspect, the base coating composition provides a composition for forming a clear coat on a metal surface. In another aspect, the base coating composition, when including a matting agent, provides a composition for forming a matte coating on a metal surface.

A. Components of the Coating Forming Composition

Alkoxysilane (i)

In embodiments, the alkoxysilane (i) is selected from an alkoxysilane of Formula A and/or Formula B:

(X—R¹)ₐSi(R²)_{b}(OR³)_{4-(a+b)} Formula A

(R³O)₃Si—R⁵—Si(OR³)₃ Formula B

wherein:

X is an organofunctional group, more specifically a mercapto, acyloxy, glycidoxy, epoxy, epoxycyclohexyl, epoxycyclohexylethyl, hydroxy, episulfide, acrylate, methacrylate, ureido, thioureido, vinyl, allyl, —NHCOOR⁴, or —NHCOSR⁴ group in which R⁴ is a monovalent hydrocarbyl group containing from 1 to about 12 carbon atoms, in embodiments from 1 to about 8 carbon atoms, thiocarbamate, dithiocarbamate, ether, thioether, disulfide, trisulfide, tetrasulfide, pentasulfide, hexasulfide, polysulfide, xanthate, trithiocarbonate, dithiocarbonate, a fluoro group, or an isocyanurato group, or another —Si(OR³) group wherein R³ is as hereinafter defined;

each R¹ is a linear, branched, or cyclic divalent organic group of from 1 to about 12 carbon atoms, from 1 to about 10 carbon atoms, or from 1 to about 8 carbon atoms, e.g., a divalent hydrocarbon group such as the non-limiting examples of methylene, ethylene, propylene, isopropylene, butylene, isobutylene, cyclohexylene, arylene, aralkylene or alkarylene group, and optionally containing one or more heteroatoms such as the non-limiting examples of O, S, and NR⁶ in which R⁶ is hydrogen or an alkyl group of from 1 to 4 carbon atoms;

each R² independently is chosen from an alkyl, aryl, alkaryl, or aralkyl group of from 1 to about 16 carbon atoms, from 1 to about 12 carbon atoms, or from 1 to 4 carbon atoms, and optionally containing one or more halogen atoms, more specifically a fluorine atom;

each R³ independently is an alkyl group of from 1 to about 12 carbon atoms, more specifically from 1 to about 8 carbon atoms, and still more specifically from 1 to 4 carbon atoms;

R⁵ is a linear, branched, or cyclic divalent organic group of from 1 to about 12 carbon atoms, from 1 to about 10 carbon atoms, or from 1 to about 8 carbon atoms, e.g., a divalent hydrocarbon group such as the non-limiting examples of methylene, ethylene, propylene, isopropylene, butylene, isobutylene, cyclohexylene, arylene, aralkylene or alkarylene group, and optionally containing one or more heteroatoms such as the non-limiting examples of O, S, and NR⁶ in which R⁶ is hydrogen or an alkyl group of from 1 to 4 carbon atoms; and

subscript a is 0 or 1, subscript b is 0, 1 or 2 and a+b is 0, 1, or 2.

In one embodiment, the total amount of alkoxysilane of Formulas A and B does not exceed about 80 weight percent, about 70 weight percent, about 60 weight percent, 50 weight percent, about 45 weight percent, even about 40 weight percent of the coating forming composition. In one embodiment, the alkoxysilane (i) is present in the coating composition an amount of about 20 to about 80 weight percent; about 25 to about 70 weight percent, about 30 to about 50 weight percent, or about 35 to about 40 weight percent based on the weight of the composition.

In one embodiment, alkoxysilane (i) can be chosen from one or more of a dialkoxysilane, trialkoxysilane, and/or tetraalkoxysilane of Formula A, and/or one or more of a trialkoxysilane of Formula B as described above provided at least one such trialkoxysilane is included therein.

Examples of dialkoxysilanes of Formula A include, but are not limited to, dimethyldimethoxysilane, diethyldiethoxysilane, diethyldimethoxysilane, 3-cyanopropylphenyldimethoxysilane, diphenyldimethoxysilane, diphenyldiethoxysilane, di(p-tolyl)dimethoxysilane, bis(diethylamino)dimethoxysilane, bis(hexamethyleneamino)dimethoxysilane, bis(trimethylsilylmethyl)dimethoxysilane, vinylphenyldiethoxysilane, and the like, and their mixtures. As explained above the alkoxysilanes, including the dialkoxysilanes, also include hydrolysed and condensed products thereof (oligomers).

In one embodiment, the at least one alkoxysilane (i) selected from the group consisting of Formulas A and/or B can be also hydrolyzed and condensed products thereof. Such products oligomers of the alkoxysilane (i) are selected from the group consisting of Formulas A and B, and the like. They are prepared by hydrolysis and condensation of the alkoxysilanes (i) selected from the group consisting of Formulas A and B. That is, alkoxysilyl groups react with water, liberating the corresponding alcohol, and then the resulting hydroxysilyl groups condense with the formation of Si—O—Si (siloxane groups). The resulting hydrolysed and condensed products or oligomers can be for example linear or cyclic polysiloxanes comprising from 2 to 30 siloxy units, preferably from 2 to 10 siloxy units, and remaining alkoxy groups. Specific exemplary examples of such oligomers include in particular oligomeric glycidoxypropyl-trimethoxysilane.

Examples of trialkoxysilanes of Formula A include, but are not limited to methyltrimethoxysilane, methyltriethoxysilane, ethyltrimethoxysilane, ethyltriethoxysilane, ethyltripropoxysilane, n-propyltrimethoxysilane, n-propyltriethoxysilane, n-propyltripropoxysilane, n-propyltributoxysilane, n-butyltrimethoxysilane, isobutyltrimethoxysilane, n-pentyltrimethoxysilane, n-hexyltrimethoxysilane, isoocyltriethoxysilane, vinyltrimethoxysilane, vinyltriethoxysilane, phenyltrimethoxysilane, phenyltriethoxysilane, octyltrimethoxysilane, trifluoropropyltrimethoxysilane, 3-aminopropyltrimethoxysilane, 3-mercaptopropyltrimethoxysilane, 3-mercaptopropyltriethoxysilane, 3-glycidoxypropyltrimethoxysilane, 3-glycidoxypropyltriethoxysilane, oligomers and mixtures of two or more thereof. Of these, methyltrimethoxysilane, octyltrimethoxysilane, and glycidoxypropyltrimethoxysilane are exemplary trialkylsiloxanes. As explained above the alkoxysilanes, including the trialkoxysilanes, also include hydrolysed and condensed products thereof (oligomers).

Examples of tetraalkoxysilanes (i.e., tetraalkyl orthosilicates) of Formula A include, but are not limited to, tetramethoxysilane, dimethoxydiethoxysilane, tetraethoxysilane, methoxytriethoxysilane, tetrapropoxysilane, and the like, and mixtures of two or more thereof.

Examples of trialkoxysilanes of Formula B include, but are not limited to, 1,2-bis(trimethoxysilyl)ethane, 1,2-bis(triethoxysilyl)ethane, bis(trimethoxysilylpropyl)disulfide, bis(triethoxysilylpropyl)disulfide, bis(trimethoxysilylpropyl)tetrasulfide, bis(triethoxysilylpropyl)tetrasulfide, bis(3-triethoxysilylpropyl)amine, bis(3-trimethoxysilylpropyl)amine, and the like, and mixtures of two or more thereof.

Metal Oxide (ii)

The present compositions include a metal oxide chosen from silica nano-particles. In one embodiment, the silica nano-particles are chosen from a colloidal silica. The colloidal silica components are generally provided in the form of particles, e.g., approximately spherical or equiaxial particles, ranging in average particle size from about 5 nm to about 500 nm, from about 10 to about 200 nm, or from about 10 to about 60 nm. The average particle sizes may be determined by any suitable method or device including, for example, by Low Angle Laser Light Scattering (LALLS) using the full Mie theory, in particular, using Mastersizer 2000 or 3000, Malvern Instruments).

In one embodiment the metal oxide (ii) is provided as an aqueous colloidal dispersion. Aqueous dispersions of colloidal silica include those having an average particle size ranging from about 5 to about 150 nm, from about 20 to about 100 nm, or from about 40 to 80 nm. In one embodiment, the colloidal silica has an average particle size of from about 5 to about 30 nm. Suitable colloidal silica dispersions include commercially available ones such as, for example, Ludox® (Sigma Aldrich), Snowtex® (Nissan Chemical), and Bindzil® (AkzoNobel) and Nalco® Colloidal Silica (Nalco Chemical Company), Levasil® (AkzoNobel). Such dispersions are available in the form of acidic and basic hydrosols.

Both acidic and basic colloidal silica can be incorporated in the coating compositions. Colloidal silicas having a low alkali content may provide a more stable coating composition. Particularly suitable colloidal silicas, but are not limited to, include Nalco® 1034A (Nalco Chemical Company) and Snowtex® O40, Snowtex ST-033 and Snowtex® OL-40 (Nissan Chemical), Ludox® AS40 and Ludox HS 40 (Sigma-Aldrich), Levasil 200/30 and Levasil® 200 S/30 (now Levasil CS30-516P) (AkzoNobel) and Cab-O-Sperse® A205 (Cabot Corporation).

The total amount of the colloidal silica may in general vary from about 5 to about 50, from about 10 to about 40, or from about 10 to about 30, weight percent based on the weight of the composition. Here as elsewhere in the specification and claims, numerical values may be combined to form new and non-specified ranges.

The amount of the metal oxide (ii) in the coating composition may in general vary from about 1 to about 50, from about 5 to about 40, from about 10 to about 30, or from about 10 to about 20 weight percent based on the weight of the composition. The weights are given for the colloidal dispersion on the total weight of the composition as opposed to the total weight of the metal solids in the composition.

Zirconium Based Compound (iii)

The compositions a zirconium containing compound that may function as an adhesion promoter. Examples of suitable zirconium containing compounds include, but are not limited to, a zirconium salt, a zircoaluminate material, a zirconate material, or a combination of two or more thereof. The adhesion promoter may be present in an amount of from about 0.05 to about 10 weight percent based on the weight of the composition; from about 0.1 to about 7.5 weight percent based on the weight of the composition; from about 0.25 to about 5 weight percent based on the weight of the composition; from about 0.5 to about 2 weight percent based on the weight of the composition. Here as elsewhere in the specification and claims, numerical values may be combined to form new and non-disclosed ranges.

Zirconium salts can include, for example, an alkoxide, a halide, a carbonate, a carboxylate, or a sulfonate salt of zirconium.

Preparation of aluminum-zirconium complexes is described in the U.S. Pat. Nos. 4,539,048 and 4,539,049, each of which is incorporated herein by reference in its entirety. These patents describe zirco-aluminate complex reaction products corresponding to the empirical Formula C:

(Al₂(OR⁸O)_{c}A_{d}Bₑ)_{X}(OC(R⁹)O)_{Y}(ZrA_{f}B_{g})_{Z} Formula C

wherein X, Y, and Z are at least 1, R⁹ is an alkyl, alkenyl, aminoalkyl, carboxyalkyl, mercaptoalkyl, or epoxyalkyl group, having from 2 to 17 carbon atoms, and the ratio of X:Z is from about 2:1 to about 5:1. A and B may be halogen (e.g, chlorine) or hydroxy. In one embodiment, A and B are chloro or hydroxy, c is a numerical value ranging from about 0.05 to 2, preferably 0.1 to 1, d is a number ranging from about 0.05 to 5.5, preferably about 1 to 5; and c is a number ranging from 0.05 to 5.5, preferably about 1 to 5, provided that 2c+d+e=6 in the chelate stabilized aluminum reactant. In one embodiment, A is hydroxy and d ranges from 2 to 5, and B is chlorine and ranges from 1 to 3.8. In the aluminum containing segment of Formula C, pairs of aluminum atoms are joined by bidentate chelating ligands wherein: (1) —OR⁸O— is an alpha, beta or alpha, gamma glycol group in which R⁸ is an alkyl, alkenyl, or alkynyl group having from 1 to 6 carbon atoms, preferably an alkyl group and preferably having 2 or 3 carbon atoms, such ligands to be used exclusively or in combinations within a given composition, or (2) —OR⁸O— is an alpha-hydroxy carboxylic acid residue —OCH(R¹⁰)—COOH having from 2 to 6 carbon atoms, preferably 2 to 3 carbon atoms (i.e. preferably R¹⁰ is H or CH₃). In each instance the organic ligand is bound to two aluminum atoms through two oxygen heteroatoms. The organofunctional ligand, —OC(R⁹)O— is a moiety which can be derived from one of, or a combination of, the following groups: (1) An alkyl, alkenyl, alkynyl, aryl or aralkyl carboxylic acid having from 2 to 18 carbon atoms, the preferred range being 2 to 6 carbon atoms; (2) an aminofunctional carboxylic acid having from 2 to 18 carbon atoms, the preferred range being 2 to 6 carbon atoms; (3) a dibasic carboxylic acid having from 2 to 18 carbon atoms wherein both carboxy groups are preferably terminal, the preferred range being 2 to 6 carbon atoms; (4) acid anhydrides of dibasic acids having from 2 to 18 carbon atoms, the preferred range being 2 to 6 carbon atoms; (5) A mercapto functional carboxylic acid having from 2 to 18 carbon atoms, the preferred range being 2 to 6 carbon atoms; or (6) An epoxy functional carboxylic acid having from 2 to 18 carbon atoms, preferably from 2 to 6 carbon atoms.

The variables f and g have a numerical value from 0.05 to 4, provided that d+e=4 in the zirconium oxyhalide metallo-organic complex reactant. In embodiments, there is at least one hydroxy group and one halogen group in the zirconium reactant. More preferably the empirical ratio of hydroxy to the zirconium in this group is from about 1-2, and the ratio of halogen to zirconium is about 2-3, in that reactant. Additional zirco-aluminate complexes are described in U.S. Pat. No. 4,650,526, the disclosure of which is incorporated herein by reference in its entirety. Non-limiting examples of suitable zircoaluminate materials include those sold under the tradename Manchem® available from FedChem.

In certain aspects, the zirconium based compounds may be a zirconate organometallic compound selected from the group consisting of: neoalkoxytris(m-aminophenyl) zirconate, neoalkoxytris(ethylenediaminoethyl) zirconate, neoalkoxytrisneodecanoyl zirconate, neoalkoxytris(dodecanoyl)benzene sulfonyl zirconate, neoalkoxytris(dodecyl)benzenesulfonyl zirconate, zirconium propionate, neoalkoxytris(dioctyl)phosphate zirconate, neoalkoxytris(dioctyl)pyrophosphate zirconate, tetra(2,2-diallyloxymethyl)butyl, bis(ditridecyl)phosphito zirconate, neopentyl(diallyl)oxytrisneodecanoyl zirconate, neopentyl(diallyl)oxytris(dodecyl)benzenesulfonyl zirconate, neopentyl(diallyl)oxytris(dioctyl)phosphate zirconate, neopentyl(diallyl)oxytris(dioctyl)pyrophosphate zirconate, tris(dioctylpyrophosphate)ethylene titanate, neopentyl(diallyl)oxytris(N-ethylenediamino)ethyl zirconate, neopentyl(diallyl)oxytris(m-amino)phenyl zirconate, neopentyl(diallyl)oxytrismethacryl zirconate, neopentyl(diallyl)oxytrisacryl zirconate, dineopentyl(diallyl)oxydiparamino benzoyl zirconate, dineopentyl(aiallyl)oxy bis(3-mercapto) propionic zirconate, zirconium IV 2-ethyl, and 2-propenolatomethyl 1,3-propanediolato, cyclo di2,2-(bis 2-propenolatomethyl)butanolato pyrophosphato-O,O,tetra(2,2 diallyloxymethyl)butyl, neopentyl(diallyl)oxy, trimethacryl zirconate, and combinations thereof. Non-limiting examples of zirconate adhesion promoters include tetra (2,2 diallyloxymethyl)butyl, di(ditridecyl)phosphito zirconate (commercially available as KZ 55 from Kenrich Petrochemicals, Inc.); neopentyl(diallyl) oxy, trineodecanoyl zirconate; neopentyl(diallyl) oxy, tri(dodecyl)benzene-sulfonyl zirconate; neopentyl(diallyl)oxy, tri(dioctyl)phosphato zirconate; neopentyl(diallyl)oxy, tri(dioctyl)-pyrophosphato zirconate neopentyl(diallyl)oxy, tri(N-ethylenediamino)ethyl zirconate; neopentyl(diallyl)oxy, tri(m-amino)phenyl zirconate; neopentyl(diallyl)oxy, trimethacryl zirconate; neopentyl(diallyl)oxy, triacryl zirconate; dineopentyl(diallyl)oxy, diparamino benzoyl zirconate; dineopentyl(diallyl)oxy, di(3-mercapto)propionic zirconate; at least partial hydrolysates thereof or mixtures thereof.

In one embodiment, the zirconium based compound has a neutral to acidic pH. In one embodiment, the zircoaluminate and/or the zirconate adhesion promoter has a pH of 7 or less, 6 or less, 5 or less or 4 or less. In one embodiment, the zircoaluminate and/or the zirconate adhesion promoter has a pH of 2-7, 3-6, or 4-5.

Acid Hydrolysis Catalyst (iv)

Any acidic hydrolysis catalysts suitable for the hydrolysis of alkoxysilanes can be incorporated in the present coating forming compositions. Illustrative acid hydrolysis catalysts (iv) include, but are not limited to, sulfuric acid, hydrochloric acid, acetic acid, propanoic acid, 2-methyl propanoic acid, butanoic acid, pentanoic acid (valeric acid), hexanoic acid (caproic acid), 2-ethylhexanoic acid, heptanoic acid (enanthic acid), hexanoic acid, octanoic acid (caprylic acid), oleic acid, linoleic acid, linolenic acid, cyclohexanecarboxylic acid, cyclohexylacetic acid, cyclohexenecarboxylic acid, benzoic acid, benzeneacetic acid, propanedioic acid (malonic acid), butanedioic acid (succinic acid), hexanedioic acid (adipic acid), 2-butenedioic acid (maleic acid), lauric acid, stearic acid, myristic acid, palmitic acid, isoanoic acid, versatic acid, lauric acid, stearic acid, myristic acid, palmitic acid, isoanoic acid, aminoacids, and mixtures of two thereof. The acid hydrolysis catalyst can be used undiluted or in the form of an aqueous solution.

Acid hydrolysis catalyst (iv) will be present in the coating forming composition of the invention in at least a catalytically effective amount which in most cases can range from about 0.1 to about 5, from about 0.5 to about 4.5, or from about 2 to about 4 weight percent based on the total weight of coating forming composition.

Water (v)

The water component of the coating forming composition herein is advantageously deionized (DI) water. Some or even all of the total water present in the coating composition-forming mixture may be added as part of one or more other components of the mixture, e.g., aqueous colloidal dispersion of metal oxides (ii), water-miscible solvent (vii), acid hydrolysis catalyst (iv), optional matting agent (vi), optional condensation catalyst (viii), and/or other optional components (ix) such as those hereinafter described.

The total amount of water (v) can range within widely varying limits, e.g., from about 5 to about 40, more specifically from about 5 to about 30 and still more specifically from about 5 to about 15, weight percent based on the total weight of coating forming composition.

Matting Agent (vi)

In one embodiment, the coating composition optionally further includes a matting agent. In the absence of the matting agent, the composition provides a clear coat when applied to (and cured) on a metal surface. In compositions that include a matting agent, the resulting coating exhibits a matte finish.

The matting agent may be either a matting agent composed of an inorganic compound or a matting agent composed of an organic compound.

Examples of inorganic compounds suitable as a matting agent include, but are not limited to, an inorganic compound include silicon-containing inorganic compounds (e.g., silicon dioxide, calcined calcium silicate, hydrated calcium silicate, aluminum silicate, magnesium silicate, etc.), titanium oxide, zinc oxide, aluminum oxide, barium oxide, zirconium oxide, strontium oxide, antimony oxide, tin oxide, antimony-doped tin oxide, calcium carbonate, talc, clay, calcined kaolin, calcium phosphate, and the like. Combinations of such materials may also be used. Particularly suitable are silicon-containing inorganic compounds. As fine particles of silicon dioxide, for example, commercially available products under such trade names as Aerosil R972, R974, R812, 200, 300, R202, OX50, and TT600 (manufactured by Nippon Aerosil Co., Ltd.) may be used.

In one embodiment, the matting agent is provided by functionalized silica particles. In one embodiment, the functionalized silica particles comprise an organic surface treated silica. The surface treatment may include treating the silica with a silanizing agent. Silanizing agents include halosilanes, alkoxysilanes, silazanes and/or siloxanes. Examples of treated silica particles suitable as the matting agent include, but are not limited to, described in U.S. Patent Publication US 2004/0120876, which is hereby incorporated by reference. Non-limiting examples of materials suitable for use as the matting agent include materials sold under the tradename SYLOID from W.R. Grace, and/or ACEMATT from Evonik.

Examples of organic compounds suitable as the matting agent include, but are not limited to, polymers such as silicone resins, fluororesins, acrylic resins, etc. Above all, more preferred are silicone resins. Non-limiting examples of suitable organic compounds include those sold under the tradename TOSPEARL from Momentive Performance Materials including, but not limited to, TOSPEARL 103, TOSPEARL 105, TOSPEARL 108, TOSPEARL 120, TOSPEARL 145, TOSPEARL 3120 and TOSPEARL 240, etc.

The matting agent, when included in the composition, may be present in an amount as desired for a particular purpose or intended application. In particular, the amount of matting agent may be chosen to provide a desired matting effect, e.g., a particular gloss, distinctness of image (DOI), etc. In one embodiment, the matting agent is provided in an amount of from about 0 to about 10 weight percent; from about 0.1 to about 10 weight percent; from about 0.2 to about 8 weight percent; or from about 0.5 to about 3 weight percent based on the weight of the composition. Further, it will be appreciated that the matting agent can include a mixture of two or more matting agents including mixtures of an inorganic compound type matting agent and an organic compound type matting agent.

Water-Miscible Organic Solvent (vii)

Illustrative of water-miscible solvent(s) (vii) that may be incorporated in the coating forming composition are alcohols such as methanol, ethanol, propanol, isopropanol, n-butanol, tert-butanol, methoxypropanol, ethylene glycol, diethyleneglycol butyl ether, and combinations thereof. Other water-miscible organic solvents such as acetone, methyl ethyl ketone, ethylene glycol monopropyl ether and 2-butoxy ethanol can also be utilized. Typically, these solvents are used in combination with water, the latter together with any water associated with metal oxide (ii) and/or other component(s) of the coating composition providing part or all of water (v) thereof.

The total amount of water-miscible solvent(s) (vii) present in the coating forming composition can vary widely, e.g., from about 10 to about 80, from about 10 to about 65, from about 10 to about 60, or from about 10 to about 50, weight percent based on the total weight thereof.

Optional Condensation Catalyst (viii)

Optional condensation catalyst (viii) catalyzes the condensation of partially or completely hydrolyzed silane components (A) and (B) of the coating forming composition herein and thus functions as a cure catalyst.

While the coating forming composition can be cured in the absence of optional condensation catalyst (viii), efficient curing may require more intensive conditions, e.g., the application of elevated temperature (thermal curing) and/or extended cure times, both of which may be undesirable from a cost and/or productivity standpoint. In addition to providing for a more economical coating process, the use of optional condensation catalyst (viii) generally results in improved curing of the coating forming composition.

Examples of materials suitable as the condensation catalysts (viii) that may optionally be present in the coating forming composition include, but are not limited to, tetrabutylammonium carboxylates of the formula [(C₄Hg)₄N]⁺[OC(O)—R⁷]⁻ in which R⁷ is selected from the group consisting of hydrogen, alkyl groups containing from 1 to about 8 carbon atoms, and aromatic groups containing about 6 to about 20 carbon atoms. In exemplary embodiments, R⁷ is a group containing about 1 to 4 carbon atoms, such as methyl, ethyl, propyl, isopropyl, butyl or isobutyl. Compared to more active types of condensation catalysts (viii), e.g., mineral acids and alkali metal hydroxides, the foregoing tetrabutylammonium carboxylates being somewhat milder in their catalytic action tend to optimize the shelf life of the coating forming compositions containing them. Exemplary tetrabutylammonium carboxylate condensation catalysts of the foregoing formula are tetra-n-butylammonium acetate (TBAA), tetrabutylammonium formate, tetra-n-butylammonium benzoate, tetra-n-butylammonium-2-ethylhexanoate, tetra-n-butylammonium-p-ethylbenzoate, and tetra-n-butylammonium propionate. Particularly suitable condensation catalysts are tetrabutylammonium carboxylate, tetra-n-butylammonium acetate (TBAA), tetra-n-butylammonium formate, tetra-n-butylammonium benzoate, tetra-n-butylammonium-2-ethylhexanoate, tetra-n-butylammonium-p-ethylbenzoate, tetra-n-butylammonium propionate, tetramethylammonium acetate, tetramethylammonium benzoate, tetrahexylammonium acetate, dimethylanilium formate, dimethylammonium acetate, tetramethylammonium carboxylate, tetramethylammonium-2-ethylhexanoate, benzyltrimethylammonium acetate, tetraethylammonium acetate, tetraisopropylammonium acetate, triethanol-methylammonium acetate, diethanoldimethylammonium acetate, monoethanoltrimethylammonium acetate, ethyltriphenylphosphonium acetate, TBD acetate (1,5,7-Triazabicyclo[4.4.0]dec-5-ene (TBD)), as well as combinations of two or more thereof.

Of the foregoing tetrabutylammonium carboxylate condensation catalysts, tetra-n-butylammonium acetate, and tetra-n-butylammonium formate are particularly suitable materials.

Where utilized, condensation catalyst (viii) can be present in the coating forming composition in at least a catalytically effective amount, e.g., from about 0.0001 to about 1 weight percent based on the total weight of the composition.

Other Optional Components (ix)

One or more other optional components (ix) are suitable for inclusion in the coating forming composition herein. Examples of other components include, but are not limited to, surfactants, antioxidants, dyes, fillers, colorants, plasticizers, UV absorbers, light stabilizers, slip additives, etc.

The coating forming composition can also include one or more surfactants functioning as leveling agents or flow additives. Examples of suitable surfactants include fluorinated surfactants such as Fluorad® (3M), silicone polyethers such as Silwet® and CoatOSil® (Momentive Performance Materials, Inc.), and silicone surface additives such as polyether-modified silicones, such as BYK-302 (BYK Chemie USA).

The coating composition can also include one or more UV absorbers such as benzotriazole, benzophenones, or dibenzoylresorcinol or their derivatives. Suitable UV absorbers include those capable of co-condensing with silanes, specific examples of which include 4-[gamma-(trimethoxysilyl) propoxyl]-2-hydroxy benzophenone, 4-[gamma-(triethoxysilyl) propoxyl]-2-hydroxy benzophenone and 4,6-dibenzoyl-2-(3-triethoxysilylpropyl) resorcinol. When UV absorbers that are capable of co-condensing with silanes are used, it is important that the UV absorber co-condenses with other reacting species by thoroughly mixing the thermally curable coating composition herein before applying it to the surface of a metal. Co-condensing the UV absorber prevents coating performance loss that may be caused by the leaching of free UV absorbers to the environment during weathering.

The coating forming composition can also include one or more antioxidants such as a hindered phenol (e.g. Irganox® 1010 (Ciba Specialty Chemicals), dyes such as methylene green, methylene blue, and the like), fillers such as, but not limited to, Titanium dioxide, zinc phosphate, barytes, aluminum flakes, etc., and/or a plasticizer such as, but not limited to, dibutylpthalate.

Pigments suitable for use herein are all inorganic and organic colors/pigments. These are usually aluminum, barium or calcium salts or lakes. A lake is a pigment that is extended or reduced with a solid diluent or an organic pigment that is prepared by the precipitation of a water-soluble dye on an adsorptive surface, which usually is aluminum hydrate. A lake also forms from precipitation of an insoluble salt from an acid or basic dye. Calcium and barium lakes are also used herein. Other colors and pigments can also be included in the compositions, such as pearls, titanium oxides, Red 6, Red 21, Blue 1, Orange 5, and Green 5 dyes, chalk, talc, iron oxides and titanated micas. The colors/pigments may also be in the form of pigment pastes/colorants.

B. Formation of the Coating Forming Composition.

In the formation of the thermally curable coating composition of the invention, reacting a mixture of alkoxysilane(s) (i) and a portion of the acid hydrolysis catalyst (iv), subsequent addition of the remaining portion of acid hydrolysis catalyst (iv), and the other components (e.g., nanoparticles, zirconium based compound, water, optional solvents, optional condensation catalyst, optional other additives, etc.), and aging of the resulting mixture under predetermined conditions of elevated temperature and time leads to a thermally curable composition having a viscosity range of from about 3.0 to about 7.0 cStks, in another embodiment more specifically from about 4.0 to about 5.5 cStks and still in another embodiment more specifically from about 4.5 to about 5.0 cStks. Viscosity can be measured, if necessary, at 25° C. in accordance with the DIN 53015 standard, “Viscometry—Measurement of Viscosity by Means of the Rolling Ball Viscometer by Hoeppler” employing a Hoeppler Falling Ball Viscometer Model 356-001 equipped with a Haake DC10 temperature control unit and ball set 800-0182, in particular, ball no. 2 having a diameter of 15.598 mm, a weight of 4.4282 g and a density of 2.229 g/cm³.

Reacting can be done for example by using an ice bath, ice/NaCl mixture or dry ice/isopropanol mixture. More specifically the alkoxysilanes (i) and the acid hydrolysis catalyst (iv) are placed in a glass bottle and then placed in an ice bath to chill the mixture while monitoring temperature through an external thermometer.

In a first stage of the process of forming the thermally curable coating composition, a mixture of trialkoxysilane of Formulas A and/or B, optional dialkoxysilane and/or tetraalkoxysilane of Formula A and from about 10 to about 40 percent of the total amount of acid hydrolysis catalyst (iv) are mixed. This may be done with chilling of the mixture. Metal oxide (ii), e.g., aqueous colloidal silica and water (v), is slowly added to the mixture.

Following the addition of metal oxide (ii) and with constant stirring the mixture is allowed to rise in temperature to or about ambient, e.g., from about 20° C. to about 30° C. During this period of continuous stirring, the alkoxysilane component(s) (i) of the mixture undergo an initial level of hydrolysis followed by condensation of the resulting hydrolyzates.

In a second stage of the process for forming the thermally curable coating composition herein, water-miscible solvent(s) (vii) and the remaining acid hydrolysis catalyst (iv) are added to the now ambient temperature reaction medium and under continuous stirring over a period of, e.g., from about 5 to about 24, and more specifically from about 8 to about 15, hours during which further hydrolysis of silanes and/or partial hydrolyzates and condensation of the thus-formed hydrolyzates thereof takes place.

The adhesion promoter (iii) may be added at any point at, during, or following any of steps (a)-(d).

If utilized, an optional condensation catalyst (viii) may be added in at least a catalytically effective amount at, during or following any of steps (a)-(d) of preparing the curable coating composition. The amounts of optional condensation catalyst (viii) can vary widely, e.g., from about 0.01 to about 0.5, and more specifically from about 0.05 to about 0.2, weight percent based on the total weight of coating forming composition.

Following this additional period of hydrolysis, optional condensation catalyst (viii) and one or more other optional components (ix) may be added to the reaction mixture, advantageously under continuous stirring for a further period of time, e.g., for from about 1 to about 24 hours. The resulting reaction mixture is now ready for aging.

Aging of the foregoing coating composition-forming mixture is carried out at elevated temperature over a period of time which has been experimentally determined to result in a viscosity within the aforestated range of from about 3.0 to about 7.0 cStks. Achieving such viscosity results in a curable coating composition with good-to-excellent cured coating properties. A lower viscosity may lead to reduced hardness of the coating film and to post curing that may occur on continued exposure of the coating. A higher viscosity may lead to cracking of the coating film during curing and subsequent exposure conditions.

For many coating composition-forming mixtures, a viscosity within the range of from about 3.0 to about 7.0 cStks can be achieved by heating the coating-forming mixture in an air oven, e.g., to a temperature of from about 25 to about 100° C. for from about 30 min. to about 1 day, more specifically at a temperature of from about 25 to about 75° C. for from about 30 min. to about 5 days and still more specifically at a temperature from about 25 to about 50° C. for from about 3 to about 10 days. The hydroxyl-containing hydrolyzable silane is partially hydrolyzed when less than an equivalent amount of water reacts with the hydrolyzable silyl group. The silane is considered partially hydrolyzed when the percent hydrolysis is in the range of about 1 to about 94 percent. The hydroxyl-containing hydrolyzable silane is considered substantially fully hydrolyzed when the percent hydrolysis is in the range of from about 95 to about 100 percent. The partially hydrolyzed hydroxyl-containing hydrolyzable silane has better stability in an aqueous solution because the R¹O—Si group terminates the polymerization reaction of the silanol condensation and maintains a lower average molecular weight oligomeric composition that is derived from the hydroxyl-containing hydrolyzable silane. The lower average molecular weight oligomeric composition adsorbs more uniformly onto the metal substrate resulting in better adhesion.

The matting agent particles are added while stirring. If the matting particles start to settle out of solution (e.g., after an extended period of time between making the composition and using the composition), the matting agents can be re-dispersed easily by simple mixing, and the formulation can be used to prepare the coating. In one embodiment, the matting agent is added subsequent to formation of the clear coat composition. In another embodiment, the matting agent may be added at any stage of the formation of the coating composition.

C. Coating Application and Curing Procedures

The coating forming composition of the invention, with or without the further addition of added solvent(s), will typically have a solids content of from about 10 to about 50, from about 15 to about 40, or from about 20 to about 30, weight percent. The pH of the coating composition will often come within the range of from about 3 to about 7, and more specifically from about 4 to about 6.

The curable coating composition can be coated onto a metal substrate with or without the use of a primer. In embodiments, the coating composition is coated onto a metal substrate without a primer.

The coating composition can be applied to a variety of substrates. Examples of suitable substrates include metals, metal alloys, painted metals or metal alloys, passivated metal or metal alloys, metallized plastics, metal sputtered plastics, primed plastic materials, etc. Suitable metals include, but are not limited to, steel, chrome, stainless steel, aluminum, anodized aluminum, magnesium, copper, bronze, alloys of each of these metals, and the like.

The coating forming composition can be applied to a metal surface or other substrate employing any conventional or otherwise known technique such as, but not limited to, spraying, brushing, flow coating, dip-coating, etc. The coating thicknesses of the as-applied (or wet) coating can vary over a fairly broad range, such as from about 10 to about 150, from about 20 to about 100, or from about 40 to about 80 microns. Wet coatings of such thicknesses will generally provide (dried) cured coatings having thicknesses ranging from about 1 to 30, from about 2 to about 20, or from about 5 to about 15 microns.

As the coating dries, solvent(s) (vii) and any other readily volatile material(s) will evaporate and the applied coating will become tack free to the touch in about 15 to about 30 minutes. The coating layer/film is then ready for curing via any conventional or otherwise known or later discovered thermal curing procedures. The operational requirements of thermal curing procedures are well known in the art. For example, thermally accelerated curing may be carried out within a temperature regime of from about 80 to about 200° C. over a period of from about 30 to about 90 minutes to provide a cured, hard protective coating that is either optically clear or exhibits a matte finish (based on the composition) on the substrate metal.

As previously described, for matte finishes, the compositions can be provided to provide the desired finish for a particular application or intended use in terms of gloss, distinctness of image, or other suitable property to evaluate such finishes. Gloss can be evaluated using any suitable device and method to measure gloss. In one embodiment, gloss is measured using a BYK Micro-TRI-Gloss Meter.

The cured coating obtained from the coating forming compositions may be in direct contact with the metal surface, may serve as the sole coating therein, may be superimposed upon one or more other coatings, and/or may itself possess one or more other coatings superimposed thereon. The cured coating composition, in addition to imparting corrosion and/or abrasion resistance properties to its metal substrate may also function as an aesthetic coating in which case it will constitute the sole or outermost coating on the metal substrate.

The advantages of the present coating forming composition over known alkoxy silane-based coating forming compositions include the exceptional storage stability, ease of its application to any of a variety of metal and metalized surfaces, and the dependably uniform properties of the cured coating.

As previously indicated, the present cured coating composition exhibits outstanding properties including a high level of adhesion to its metal substrate, corrosion resistance, flexibility (resistance to cracking and crazing), abrasion/wear resistance, optical clarity or matte appearance.

### EXAMPLES

### Examples 1-15

Examples 1-15 illustrate the preparation of coating forming compositions in accordance with aspects and embodiments of the present compositions and their performance as cured coatings on bare/bulk aluminum panels of 15 cm length, 10 cm width and 1 mm thickness.

The starting components of the curable coating forming compositions of Examples 1-15 are listed in Table 1 below:

TABLE 1
Starting Materials

| Component | | Chemical Name | Source (Grade name) |
|---|---|---|---|
| Trialkoxysilane | 1a | Methyltrimethoxy silane (MTMS) | Momentive (A-1630) |
| Catalyst | 2a | Acetic acid | Sigma Aldrich |
| | 2b | Tetrabutyl ammonium acetate (TBAA) | Momentive |
| | | condensation catalyst (40 wt % in Water) | |
| Metal oxide | 3a | Aqueous colloidal silica (SiO₂), 40 weight | W. R. Grace (LUDOX AS-40) |
| | | percent solids | |
| | 3b | Alumina (Al₂O₃) dispersion in Iso-propanol (20 | Sigma Aldrich |
| | | wt %) | |
| | 3c | Levasil 100S/45 | Akzo Nobel |
| | 3d | Levasil 200S/30 | Akzo Nobel |
| Deionized water | 4 | Deionized water | |
| Solvent | 5 | 2-propanol | Aldrich |
| | 6 | n-butanol | Aldrich |
| Silicone surface | 7 | BYK-302 flow additive (1% in 1-methoxy-2- | BYK Chemie |
| additive | | propanol) | |
| Adhesion Promoter | 8a | Manchem ® FPM | Fedchem |
| | 8b | Manchem ® CPM | |
| | 8c | Manchem ® 441 | |
| | 9 | KZ-TPP | Kenrich Petrochemicals, Inc. |

Preparation of Coating Formulations

A glass bottle was charged with acetic acid and trialkoxy silane. After cooling the reaction mixture in an ice bath approximately to 0° C., a mixture of silica nano particles and water were drop wise added to the chilled mixture of silanes and acetic acid while maintaining the temperature approximately below 10° C. After 12-14 hours while the solution temperature slowly increased to room temperature, alcohols and remaining acetic acid were added following which the adhesion promoter, TBAA catalyst and flow additive were added. After this, the formulations were aged at 50° C. in a hot air oven prior to coating on metal surface.

Employing the starting materials listed in Table 1 and the general preparative procedures described above, the curable coating forming compositions of Examples 1-15 were prepared from the indicated mixtures set forth in Tables 2 below. Compositions of comparative examples are set forth in Table 3.

TABLE 2

| Input | | EX. 1 | EX. 2 | EX. 3 | EX. 4 | EX. 5 | EX. 6 | EX. 7 | EX. 8 |
|---|---|---|---|---|---|---|---|---|---|
| Acetic Acid | 2a | 0.84 | 0.84 | 0.84 | 4.20 | 4.20 | 4.20 | 4.20 | 4.20 |
| MTMS | 1a | 35.44 | 35.44 | 35.44 | 177.20 | 177.20 | 177.20 | 177.20 | 177.20 |
| Ludox AS40 | 3a | 14.26 | 14.26 | 14.26 | 71.30 | 71.30 | 71.30 | 71.30 | 71.30 |
| Additional | 4 | 12.60 | 12.60 | 12.60 | 63.00 | 63.00 | 63.00 | 63.00 | 63.00 |
| Water | | | | | | | | | |
| Iso-propanol | 5 | 16.63 | 16.63 | 16.63 | 83.15 | 83.15 | 83.15 | 83.15 | 83.15 |
| n-Butanol | 6 | 16.42 | 16.42 | 16.42 | 82.10 | 82.10 | 82.10 | 82.10 | 82.10 |
| Acetic Acid | 2a | 1.89 | 1.89 | 1.89 | 9.45 | 9.45 | 9.45 | 9.45 | 9.45 |
| 1% BYK302 (in | 7 | 1.82 | 1.82 | 1.82 | 9.10 | 9.10 | 9.10 | 9.10 | 9.10 |
| PM) | | | | | | | | | |
| TBAA (39.9%) | 2b | 0.10 | 0.10 | 0.10 | 0.52 | 0.52 | 0.52 | 0.52 | 0.52 |
| Adhesion | 8a | 0.25 | 0.00 | 0.00 | 5.00 | 0.00 | 7.50 | 0.00 | 2.50 |
| Promoters | 8b | 0.00 | 0.25 | 0.00 | 0.00 | 5.00 | 0.00 | 7.50 | 0.00 |
| | 8c | 0.00 | 0.00 | 0.25 | 0.00 | 0.00 | 0.00 | 0.00 | 0.00 |
| | 9 | 0.00 | 0.00 | 0.00 | 0.00 | 0.00 | 0.00 | 0.00 | 0.00 |

| Input | | EX. 9 | EX. 10 | EX. 11 | EX. 12 | EX. 13 | EX. 14 | EX. 15 |
|---|---|---|---|---|---|---|---|---|
| Acetic Acid | 2a | 4.20 | 2.11 | 2.11 | 2.11 | 0.84 | 0.84 | 0.84 |
| MTMS | 1a | 177.20 | 88.90 | 88.90 | 88.90 | 35.44 | 35.44 | 35.44 |
| Ludox AS40 | 3a | 71.30 | 35.77 | 35.77 | 35.77 | 14.26 | 14.26 | 14.26 |
| Additional | 4 | 63.00 | 30.75 | 30.75 | 30.75 | 12.60 | 12.60 | 12.60 |
| Water | | | | | | | | |
| Iso-propanol | 5 | 83.15 | 41.72 | 41.72 | 41.72 | 16.63 | 16.63 | 16.63 |
| n-Butanol | 6 | 82.10 | 41.19 | 41.19 | 41.19 | 16.42 | 16.42 | 16.42 |
| Acetic Acid | 2a | 9.45 | 4.74 | 4.74 | 4.74 | 1.89 | 1.89 | 1.89 |
| 1% BYK302 (in | 7 | 9.10 | 4.57 | 4.57 | 4.57 | 1.82 | 1.82 | 1.82 |
| PM) | | | | | | | | |
| TBAA (39.9%) | 2b | 0.52 | 0.26 | 0.26 | 0.26 | 0.10 | 0.10 | 0.10 |
| Adhesion | 8a | 0.00 | 0.00 | 0.00 | 0.00 | 0.00 | 0.00 | 0.00 |
| Promoters | 8b | 2.50 | 0.00 | 0.00 | 0.00 | 0.00 | 0.00 | 0.00 |
| | 8c | 0.00 | 1.25 | 2.50 | 3.75 | 0.00 | 0.00 | 0.00 |
| | 9 | 0.00 | 0.00 | 0.00 | 0.00 | 0.50 | 1.06 | 2.00 |

TABLE 3

| | | | Comparative example-2 | Comparative example-3 |
|---|---|---|---|---|
| | | Comparative example-1 | Composition with Levasil | Composition with SiO₂ & |
| Ingredients | | Composition with only SiO₂ | Particles | Al₂O₃ |
| Acetic Acid | 2a | 0.84 | 3.02 | 0.85 |
| MTMS | 1a | 35.44 | 35.55 | 35.1 |
| LUDOX AS 40 | 3a | 14.6 | 0 | 12.99 |
| Colloidal Alumina (20 wt. % | 3b | 0 | 0 | 2.27 |
| dispersion in Isopropanol) | | | | |
| Levasil 100S/45 | 3c | 0 | 3.94 | 0 |
| Levasil 200S/30 | 3d | 0 | 14.27 | 0 |
| DI Water | 4 | 12.6 | 0 | 13.29 |
| Iso-propanol | 5 | 16.63 | 21.53 | 14.85 |
| n-Butanol | 6 | 16.42 | 21.53 | 16.44 |
| Acetic Acid | 2a | 1.89 | 1.89 | 1.9 |
| BYK 302 (1% in MP) | 7 | 1.82 | 1.83 | 1.82 |
| TBAA | 2b | 0.104 | 0.116 | 0.104 |

The general procedures for applying the curable coating forming compositions of Examples 1-15 to the bare/bulk aluminum panels and curing the coatings thereon were as follows:

Coating Procedure

The metal substrate is first cleaned with isopropanol and dried in air. Application of a coating layer having an approximate thickness of 10 microns may be carried out by any suitable means, e.g., by dip, flow, or spray coating. Dip coating was used for applying an approximately 10 micron thick layer of coating forming composition to the bulk/bare aluminum panels.

Curing Procedure

After applying coatings to the bulk/bare aluminum substrates, volatiles were evaporated at about 20-25° C. resulting in the formation of tack-free coating layers within about 15-30 minutes. The coated panels were then baked in a hot air oven at 130-200° C. for 30-60 minutes to produce a completely cured, clear hard coat on the metal surfaces.

Testing of the coated metal panels was carried out as described below in Table 4:

TABLE 4
Testing of Coated Panels

| Test | Procedure |
|---|---|
| Coating Appearance | Appearance of coating was evaluated by visual inspection. To pass the appearance test, a |
| (applicable for | coating had to be smooth, glossy, optically clear and free of other visible defects. |
| Clearcoat) | |
| Coating Appearance | Appearance of the coating was evaluated by visual inspection. To pass the appearance test, |
| (applicable for Matte | a coating had to be smooth, matte appearance, clear and free of other visible defects. If |
| Coating) | desired, Gloss measurements can be done to evaluate matte appearance. |
| Adhesion of Coating to | The adhesion test was carried out in accordance with ASTM D 3359 (5B considered as best |
| Panel | adhesion, 0B considered as no adhesion) |
| Water Soak Adhesion | Adhesion testing was done according to ASTM D3359. After the initial adhesion test, |
| test | coated panels were immersed in 65° C. water for 10 days. Samples were removed at various |
| | intervals, dried and then retested for adhesion by the technique detailed above. The time to |
| | failure is estimated by determining when the adhesion fell below a value of 4B. To pass this |
| | test, coating requires to pass 5B adhesion after 10 days water immersion at 65° C. |
| Specular Gloss | Gloss measurement was done following ASTM D 523 using BYK Micro-TRI-Gloss Meter. |
| | The gloss values for the coatings reported as a range measured at 20°, 60° & 85° geometry. |
| Crockmeter Abrasion | This test is done by AATCC Crockmeter CM-5 instrument using green crocking cloths 5 cm × |
| Resistance of Coating | 5 cm (from Atlas) for 10 cycles (1 cycle = rubbing forth and back); distance: 100 mm; |
| | force: 9N (automatically applied). To pass this test, there should not be any visible scratches |
| | on the surface after the test. |
| Heat Resistance | The coated panels were maintained in a hot air oven at 160° C. for 24 hours. To pass this |
| | test, there could no observable adhesion loss, delamination or cracking. |
| Acid Resistance of | The coated panels were dipped into a pH 1.0 HCI solution for 10 minutes. The panels were |
| Coating | then removed from the solution, washed with DI water and dried at ambient temperature |
| | (approximately 23° C.). To pass this test, there could be no softening of the coating film, |
| | adhesion loss, delamination, cracking, corrosion or any other visible defects.. |
| Alkali resistance of | The coated panels were dipped into a pH 13.5 phosphate buffer solution for 10 minutes. The |
| Coating | panels were then removed from the buffer solution, washed with DI water and dried at |
| | ambient temperature (approximately 23° C.). To pass this test, there could be no softening of |
| | the coating film, adhesion loss, delamination, cracking, or corrosion or any other visible |
| | defects. |
| Humidity Resistance | This test was carried out per DIN EN ISO 6270-2-CH. To be acceptable, the coating had to |
| | pass 240 hours according to this test. |
| Copper Accelerated Salt | This test was carried out per DIN EN ISO 9227. To be acceptable, the coating had to pass 8 |
| Spray Resistance | hours according to this test. |
| (CASS) Test | |
| Neutral Salt Spray | This test was carried out per DIN EN ISO 9227. To be acceptable, a coating had to pass 480 |
| Resistance (NSS) Test | hours according to this test. |

Coating performance data are presented in Tables 5-7 as follows:

TABLE 5

| | EX. 1 | EX. 2 | EX. 3 | EX. 4 | EX. 5 | EX. 6 | EX. 7 | EX. 8 | EX. 9 | EX. 10 | EX. 11 | EX. 12 | EX. 13 | EX. 14 | EX. 15 |
|---|---|---|---|---|---|---|---|---|---|---|---|---|---|---|---|
| Coating Appearance | Good | Good | Good | Good | Good | Good | Good | Good | Good | Good | Good | Good | Good | Good | Good |
| Initial Adhesion | 0B | 5B | 5B | 5B | 0B | 5B | 5B | 5B | 0B | 0B | 0B | 0B | 4B | 5B | 5B |
| Acid resistance test | — | Pass | Pass | Pass | — | Pass | Pass | Pass | — | — | — | — | — | Pass | Pass |
| Alkaline resistance | — | Pass | Pass | Pass | — | Pass | Pass | Pass | — | — | — | — | — | Pass | Pass |
| test | | | | | | | | | | | | | | | |
| Water soak | — | Pass | Pass | Fail | — | Pass | Pass | Fail | — | — | — | — | — | 5B | 5B |
| Adhesion Test | | | | | | | | | | | | | | | |
| Crockmeter | — | Pass | Pass | Pass | — | Pass | Pass | Pass | — | — | — | — | — | — | — |
| Abrasion Resistance | | | | | | | | | | | | | | | |
| Test | | | | | | | | | | | | | | | |
| Heat Resistance | — | Pass | Pass | Pass | — | Pass | Pass | Pass | — | — | — | — | — | — | — |

TABLE 6

| | Comparative | Comparative | Comparative |
|---|---|---|---|
| | Example 1 | Example 2 | Example 3 |
| Adhesion promoter | None | None | None |
| Coating Appearance | Good | Good | Delamination |
| Initial Adhesion | 0B | 0B | 0B |

TABLE 7

| Examples | CASS test | NSS test |
|---|---|---|
| Ex. 2 | Pass | Pass |
| Ex. 14 | Pass | Pass |

As mentioned in Table 5, examples 2 to 3 and examples 6 to 7 pass all the adhesion and other tests such as abrasion and pH resistance tests (HCl and NaOH buffer solution). On the other hand, the comparative formulations mentioned in Table 3, whose test results are tabulated in Table 6, do not pass the initial adhesion test.

The other class of adhesion promoters found to be working in this particular formulation and application is Zirconium (IV) complexes particularly, KZTPP from Kenrich Petrochemicals as provided by Examples 14 and 15

Matte Coating Compositions and Coatings

Starting Materials

The starting materials for matte coating compositions are listed in Table 8.

TABLE 8

| Component | | Chemical Name | Source (Grade name) |
|---|---|---|---|
| Trialkoxysilane | 1a | Methyltrimethoxy silane (MTMS) | Momentive (A-1630) |
| Catalyst | 2a | Acetic acid hydrolysis catalyst | Sigma Aldrich |
| | 2b | Tetrabutyl ammonium acetate (TBAA) condensation catalyst (40 | Momentive |
| | | wt % in Water) | |
| Metal oxide | 3 | Aqueous colloidal silica (SiO₂), 40 weight percent solids | W. R. Grace ( LUDOX |
| | | | AS-40) |
| Deionized water | 4 | Deionized water | — |
| Solvent | 5 | 2-propanol | Aldrich |
| | 6 | n-butanol | Aldrich |
| Silicone surface | 7 | BYK-302 flow additive (1% in 1-methoxy-2-propanol) | BYK Chemie |
| additive | | | |
| Adhesion promoter | 8a | MANCHEM ® FPM | Fedchem, USA |
| | 8b | MANCHEM ® CPM | |
| Matting Agent | 9a | Syliod C-803 | W. R. Grace |
| | 9b | Syliod ED-2 | W. R. Grace |
| | 9c | TOSPEARL 120 | Momentive |
| | 9d | TOSPEARL 145 | Momentive |
| | 9e | ACEMATTE 3300 | Evonik |

The procedure of preparing the final matte coating forming compositions comprises of two steps. The first step is to prepare the corresponding clear coat forming composition followed by the second step that involves dispersing matting agent to the clear coat forming composition before application on Al surface.

Clear coat compositions were prepared as previously described. The obtained clear coating composition was taken in a round bottom flask and a required amount of matting agent particles were added while stirring at approximately 500-1000 RPM for 5-24 hrs. at room temperature. The mixture obtained was then centrifuged at 500-750 RPM for 3-5 minutes prior to the coating application.

General Procedure for Coating with Matte Coating Compositions

Prior to coating applications, an aluminum surface was cleaned with iso-propanol and dried in air. Application of a thin layer coating of approximate thickness around 5-10 microns achieved by flow coating. After coating on aluminum substrates, volatiles evaporated at ambient condition (approx. 20-25° C., 30±10% RH) and a tack free coating layer was formed within 25-30 minutes. After solvent flash off, the coated panels were baked in hot air oven between 130-200° C. for 30-60 minutes to obtain completely cured matte coating on aluminum surface.

### Matte Coating Compositions (Examples 16-19)

Matte coating compositions were prepared as described above. The compositions are listed in Table 9:

TABLE 9

| Chemicals | Component | EX. 16 | EX. 17 | EX-18 | Ex-19 |
|---|---|---|---|---|---|
| Acetic acid | 2a | 0.82 | 0.82 | 0.82 | 0.82 |
| MTMS | 1a | 34.32 | 34.32 | 34.32 | 34.32 |
| SiO2 dispersion | 3 | 13.80 | 13.80 | 13.80 | 13.80 |
| DI water | 4 | 12.21 | 12.21 | 12.21 | 12.21 |
| 2-propanol | 5 | 16.11 | 16.11 | 16.11 | 16.11 |
| n-Butanol | 6 | 15.91 | 15.91 | 15.91 | 15.91 |
| Acetic acid | 2a | 1.83 | 1.83 | 1.83 | 1.83 |
| 1% BYK 302 | 7 | 1.79 | 1.79 | 1.79 | 1.79 |
| TBAA | 2b | 0.10 | 0.10 | 0.10 | 0.10 |
| Adhesion Promoter | 8a | 0.49 | 0.49 | 0 | 0 |
| Adhesion Promoter | 8b | 0 | 0 | 0.49 | 0.49 |
| Syliod C-803 | 9a | 0.88 | 0 | 0.88 | 0 |
| Syliod ED-2 | 9b | 0 | 0.88 | 0 | 0.88 |
| Total | | 100 | 100 | 100 | 100 |

Comparative matte coating compositions are identified in Table 10. The comparative examples CE-4, CE-5 & CE-6 are prepared following the same procedure as EX-16 to EX-19. However, it is found that CE-4, CE-5 & CE-6 formulations are usable only up to few hours after dispersion of matting agents (3-5 hrs.) beyond that time matting agents starts to settle down from the coating forming formulation. The settled particles do not re-disperse completely even after vigorous mixing and hence the coating formulation cannot be re-used. CE-7 and CE-8 compositions do not have any matting agents.

TABLE 10

| Chemicals | Component | CE-4 | CE-5 | CE-6 | CE-7 | CE-8 |
|---|---|---|---|---|---|---|
| Acetic acid | 2a | 0.82 | 0.82 | 0.82 | 0.83 | 0.83 |
| MTMS | 1a | 34.32 | 34.32 | 34.32 | 35.26 | 35.26 |
| SiO2 dispersion | 3 | 13.80 | 13.80 | 13.80 | 14.18 | 14.18 |
| DI water | 4 | 12.21 | 12.21 | 12.21 | 12.53 | 12.53 |
| 2-propanol | 5 | 16.11 | 16.11 | 16.11 | 16.54 | 16.54 |
| n-Butanol | 6 | 15.91 | 15.91 | 15.91 | 16.33 | 16.33 |
| Acetic acid | 2a | 1.83 | 1.83 | 1.83 | 1.88 | 1.88 |
| 1% BYK 302 | 7 | 1.79 | 1.79 | 1.79 | 1.81 | 1.81 |
| TBAA | 2b | 0.10 | 0.10 | 0.10 | 0.103 | 0.103 |
| Adhesion Promoter) | 8a | 0.49 | 0.49 | 0.49 | 0.49 | 0 |
| Adhesion Promoter | 8b | 0 | 0 | 0 | 0 | 0.49 |
| TOSPEARL 120 | 9c | 0.88 | 0 | 0 | 0 | 0 |
| TOSPEARL 145 | 9d | 0 | 0.88 | 0 | 0 | 0 |
| ACEMATT 3300 | 9e | 0 | 0 | 0.88 | 0 | 0 |
| Total | | 100 | 100 | 100 | 100 | 100 |

Results for the matte coating compositions and the comparative matte coating compositions are provided in Tables 11-13.

TABLE 11

| Test Results | Ex.16 | Ex. 17 | Ex.18 | Ex. 19 |
|---|---|---|---|---|
| Coating Appearance | Passes | Passes | Passes | Passes |
| Gloss Values (20°) | 170-180 | 170-180 | 170-180 | 170-180 |
| Gloss Values (60°) | 200-220 | 210-230 | 210-220 | 200-220 |
| Gloss Values (85°) | 80-90 | 85-95 | 100-110 | 75-95 |
| Initial Adhesion | 5B | 5B | 5B | 5B |
| Crockmeter Abrasion Resistance | Passes | Fail | Passes | Fail |
| test | | | | |
| Hydrochloric Acid resistance | Passes | Passes | Passes | Passes |
| Alkaline resistance test | Passes | Passes | Passes | Passes |
| Heat Resistance Test | Passes | Passes | Passes | Fail |
| Water Soak Adhesion Test | Passes | Passes | Passes | Fail |
| Neutral Salt Spray test | Passes | — | Passes | — |
| CASS test | Passes | — | Passes | — |

TABLE 12

| | | Bulk/ | | |
|---|---|---|---|---|
| | Anodized | Bare- | | |
| | sample | aluminium | | |
| Tests | Uncoated | Uncoated | Ex-16 | Ex-18 |
| Visual | Matte | Glossy | Pass | Pass |
| appearance | appearance | surface | (matte | (matte |
| | | | appearance | appearance) |
| Gloss values @ | 170-180 | 600-620 | 170-180 | 170-180 |
| 20° | | | | |
| Gloss values @ | 200-210 | 680-800 | 160-170 | 160-170 |
| 60° | | | | |
| Gloss values @ | 80-90 | 50-60 | 75-85 | 75-85 |
| 85° | | | | |
| Adhesion | NA | NA | Pass | Pass |
| Crockmeter | Pass | Fails | Pass | Pass |
| abrasion | | | | |
| resistance | | | | |
| Acid Resistance | Pass | Pass | Pass | Pass |
| Alkaline | Fail | Fail | Pass | Pass |
| Resistance | | | | |
| Heat Resistance | Fail | Pass | Pass | Pass |
| NSS test | — | — | Pass | Pass |
| CASS test | — | — | Pass | Pass |
| Humidity | — | — | Pass | — |
| resistance | | | | |

TABLE 13

| Test Results | CE-4 | CE-5 | CE-6 | CE-7 | CE-8 |
|---|---|---|---|---|---|
| Coating Appearance | Passes | Passes | Passes | Fail | Fail |
| | | | | (no matte | (no matte |
| | | | | effect) | effect) |
| Gloss Values (20°) | 170-180 | 170-180 | 170-180 | 580-600 | 580-600 |
| Gloss Values (60°) | 190-210 | 190-200 | 190-210 | 700-750 | 700-750 |
| Gloss Values (85°) | 80-90 | 80-90 | 80-90 | 50-60 | 50-60 |
| Initial Adhesion | 5B | 5B | 5B | 5B | 5B |
| Crockmeter | Fail | Fail | Fail | Pass | Pass |
| Abrasion | | | | | |
| Resistance test | | | | | |

While the invention has been described above with references to specific embodiments thereof, it is apparent that many changes, modifications and variations can be made without departing from the inventive concept disclosed herein. Accordingly, it is intended to embrace all such changes, modifications and variations that fall within the spirit and broad scope of the appended claims.

1. A coating forming composition comprising:
(i) at least one alkoxysilane
(ii) silica nano-particles;
(iii) a zirconium based compound;
(iv) at least one acid hydrolysis catalyst;
(v) water;
(vi) optionally a matting agent;
(vii) optionally a solvent; and
(viii) optionally, at least one condensation catalyst.

2. The coating forming composition of claim 1, wherein the at least one alkoxy silane is selected from the group consisting of Formula A, Formula B, or a mixture of Formula A and Formula B:
(X—R¹)ₐSi(R²)_{b}(OR³)_{4-(a+b)} Formula A
(R³O)₃Si—R⁵—Si(OR³)₃ Formula B
or hydrolyzed and condensed products thereof,
wherein:
X is an organofunctional group;
each R¹ is a linear, branched or cyclic divalent organic group of from 1 to about 12 carbon atoms optionally containing one or more heteroatoms;
each R² independently is an alkyl, aryl, alkaryl or aralkyl group of from 1 to about 16 carbon atoms, optionally containing one or more halogen atoms;
each R³ independently is an alkyl group of from 1 to about 12 carbon atoms;
R⁵ is a linear, branched or cyclic divalent organic group of from 1 to about 12 carbon atoms optionally containing one or more heteroatoms; and
subscript a is 0 or 1, subscript b is 0, 1 or 2 and a+b is 0, 1 or 2.

3. The coating forming composition of claim 2, wherein the total amount of alkoxysilane of Formulas A and B does not exceed about 80 weight percent of the coating forming composition.

4. The coating forming composition according to claim 2, wherein in the alkoxysilane of Formula A, a is 1 and organofunctional group X is a mercapto, acyloxy, glycidoxy, epoxy, epoxycyclohexyl, epoxycyclohexylethyl, hydroxy, episulfide, acrylate, methacrylate, ureido, thioureido, vinyl, allyl, —NHCOOR⁴ or —NHCOSR⁴ group in which R⁴ is a monovalent hydrocarbyl group containing from 1 to about 12 carbon atoms thiocarbamate, dithiocarbamate, ether, thioether, disulfide, trisulfide, tetrasulfide, pentasulfide, hexasulfide, polysulfide, xanthate, trithiocarbonate, dithiocarbonate or isocyanurato group, or another —Si(OR³) group wherein R³ is as previously defined.

5. The coating forming composition according to claim 2, wherein in the alkoxysilane of formula B, R⁵ is a divalent hydrocarbon group containing at least one heteroatom selected from the group consisting of O, S and NR⁶ in which R⁶ is hydrogen or an alkyl group of from 1 to about 4 carbon atoms.

6. The coating forming composition according to claim 2, wherein the trialkoxysilane of Formula A is at least one member selected from the group consisting of methyltrimethoxysilane, methyltriethoxysilane, ethyltrimethoxysilane, ethyltriethoxysilane, ethyltripropoxysilane, n-propyltrimethoxysilane, n-propyltriethoxysilane, n-propyltripropoxysilane, n-propyltributoxysilane, n-butyltrimethoxysilane, isobutyltrimethoxysilane, n-pentyltrimethoxysilane, n-hexyltrimethoxysilane, isoocyltriethoxysilane, vinyltrimethoxysilane, vinyltriethoxysilane, phenyltrimethoxysilane, phenyltriethoxysilane, octyltrimethoxysilane, trifluoropropyltrimethoxysilane, 3-aminopropyltrimethoxysilane, 3-mercaptopropyltrimethoxysilane, 3-mercaptopropyltriethoxysilane, 3-glycidoxypropyltrimethoxysilane and 3-glycidoxypropyltriethoxysilane, and wherein the trialkoxysilane of Formula B is at least one member selected from the group consisting of 1,2-bis(trimethoxysilyl)ethane, 1,2-bis(triethoxysilyl)ethane, bis(trimethoxysilylpropyl)disulfide, bis(triethoxysilylpropyl)disulfide, bis(trimethoxysilylpropyl)tetrasulfide, bis(triethoxysilylpropyl)tetrasulfide, bis(3-triethoxysilylpropyl)amine, and bis(3-trimethoxysilylpropyl)amine.

7. The coating forming composition of claim 1, wherein the silica nano-particles are colloidal silica nanoparticles.

8. The coating forming composition of claim 1, wherein the colloidal silica particles are present in an amount of from about 5 to about 50 weight percent based on the weight of the composition.

9. The coating forming composition of claim 1, wherein the zirconium based compound is chosen from a zirconium salt, a zircoaluminate, a zirconate, zirconium complexes or a combination of two or more thereof.

10. The coating forming composition of claim 9, wherein the zircoaluminate, zirconium complexes, zirconium salt, and the zirconate each have a neutral or acidic pH.

11. The coating forming composition of claim 1, wherein the zirconium based compound is present in an amount of from about 0.1 to about 10 weight percent based on the weight of the composition.

12. The coating forming composition of claim 1, wherein the zirconium based compound is present in an amount of from about 0.25 to about 7.5 weight percent based on the weight of the composition.

13. The coating forming composition of claim 1, wherein the at least one acid hydrolysis catalyst is at least one member selected from the group consisting of sulfuric acid, hydrochloric acid, acetic acid, propanoic acid, 2-methyl propanoic acid, butanoic acid, pentanoic acid (valeric acid), hexanoic acid (caproic acid), 2-ethylhexanoic acid, heptanoic acid (enanthic acid), hexanoic acid, octanoic acid (caprylic acid), oleic acid, linoleic acid, cyclohexanecarboxylic acid, cyclohexylacetic acid, cyclohexenecarboxylic acid, benzoic acid, benzeneacetic acid, propanedioic acid (malonic acid), butanedioic acid (succinic acid), hexanedioic acid (adipic acid), 2-butenedioic acid (maleic acid), lauric acid, stearic acid, myristic acid, palmitic acid, isoanoic acid, versatic acid, and amino acid.

14. The coating forming composition of claim 1, wherein the coating forming composition includes the matting agent.

15. The coating forming composition of claim 14, wherein the matting agent is an inorganic compound or an organic compound.

16. The coating forming composition of claim 14, wherein the matting agent is chosen from silicon dioxide, calcined calcium silicate, hydrated calcium silicate, aluminum silicate, magnesium silicate, titanium oxide, zinc oxide, aluminum oxide, barium oxide, zirconium oxide, strontium oxide, antimony oxide, tin oxide, antimony-doped tin oxide, calcium carbonate, talc, clay, calcined kaolin, calcium phosphate, a silicone resin, a fluororesin, an acrylic resin, or a mixture of two or more thereof.

17. The coating forming composition of claim 14, wherein the matting agent is silica functionalized with a halosilane, an alkoxysilane, a silazane, a siloxane, or a combination of two or more thereof.

18. The coating forming composition of claim 14, wherein the matting agent is present in an amount of from about 0.1 to about 10 weight percent based on the weight of the composition.

19. The coating forming composition of claim 1, wherein the coating forming composition includes the solvent (vii).

20. The coating forming composition of claim 19, wherein the solvent is a water-miscible solvent selected from the group consisting of alcohol, glycol, glycol ether and ketone.

21. The coating forming composition of claim 1 wherein the coating forming composition includes the at least one condensation catalyst.

22. The coating forming composition of claim 1 wherein the at least one condensation catalyst is selected from the group consisting of tetrabutylammonium carboxylates of the formula [(C₄H₉)₄N]⁺[OC(O)—R⁷]⁻ in which R⁷ is selected from the group consisting of hydrogen, alkyl groups containing from 1 to about 8 carbon atoms, and aromatic groups containing about 6 to about 20 carbon atoms.

23. The coating forming composition of claim 1, wherein condensation catalyst is at least one member selected from the group consisting of tetra-n-butylammonium acetate, tetra-n-butylammonium formate, tetra-n-butylammonium benzoate, tetra-n-butylammonium-2-ethylhexanoate, tetra-n-butylammonium-p-ethylbenzoate, tetra-n-butylammonium propionate and TBD-acetate (1,5,7-triazabicyclo[4.4.0]dec-5-ene (TBD)).

24. The coating forming composition of claim 1, having a viscosity within the range of from about 3 to about 7 cStks at 25° C.

25. An article comprising a coating formed from the coating forming composition of claim 1 disposed on a surface of the article.

26. The article of claim 25, wherein the coated surface is formed from a metal, metal alloy, metallized part, metal or metallized part possessing one or more protective layers, metallized plastic, metal sputtered plastic, or primed plastic material.

27. The article of claim 25, wherein the coated surface comprises a metal chosen from steel, stainless steel, chrome, aluminum, anodized aluminum, magnesium, copper, bronze, or an alloy of two or more of these metals.

28. A method of forming a coating on a surface of an article comprising:
applying the coating forming composition of claim 1 on a surface of the article; and
curing the coating forming composition.

29. The method of claim 28, wherein curing the coating forming composition comprises curing at a temperature of about 80 to about 200° C.

30. A method of forming the coating forming composition according to claim 1 comprising:
a) Mixing alkoxysilane and at least one acid hydrolysis catalyst;
b) adding at least one metal oxide and water to the mixture of step (a);
c) adding at least one water-miscible solvent and additional acid hydrolysis catalyst to the mixture resulting from step (b);
d) adding the zirconium containing compound, optional condensation catalyst, and/or other optional additives to the mixture of either step (a), step (b), or step (d);
e) aging the mixture resulting from step (d) under conditions of elevated temperature and for a period of time effective to provide a curable coating forming composition having a viscosity within the range of from about 3.0 to about 7.0 cStks at 25° C.; and,
e) optionally adding a condensation catalyst at, during, or following any of the preceding steps.

31. The method of claim 30 comprising adding a matting agent following step (c) or (d).
